(19) United States
(12) Patent Application Publication
(10) Pub. No.: US 2025/0245461 A1
(43) Pub. Date: Jul. 31, 2025

(54) IMAGE FORMING APPARATUS

(71) Applicants: Kazuhiro Ikeda, KANAGAWA (JP); Masaki Tsugawa, KANAGAWA (JP); Tomohiko Kaneko, KANAGAWA (JP); Yuta Maeda, KANAGAWA (JP)

(72) Inventors: Kazuhiro Ikeda, KANAGAWA (JP); Masaki Tsugawa, KANAGAWA (JP); Tomohiko Kaneko, KANAGAWA (JP); Yuta Maeda, KANAGAWA (JP)

(73) Assignee: Ricoh Company, Ltd., Tokyo (JP)

(21) Appl. No.: 19/013,367

(22) Filed: Jan. 8, 2025

(30) Foreign Application Priority Data
Jan. 29, 2024 (JP) 2024-010951

(51) Int. Cl. G06K 15/02; H04N 1/00

(52) U.S. Cl. CPC G06K 15/1809; H04N 1/00896

(57) ABSTRACT

An image forming apparatus includes an image reading device to read an image of a document to acquire image data, a printing device to print an image on a recording medium based on print data, and circuitry to communicate with the image reading device and the printing device via electrical interfaces and generate first print data based on the image data acquired by the image reading device in a first state. In a case of a second state in which the circuitry does not generate the first print data, the image reading device generates second print data based on the acquired image data. The printing device prints an image on a recording medium based on the first print data in a case of the first state, and prints an image on a recording medium based on the second print data in the case of the second state.

### CROSS-REFERENCE TO RELATED APPLICATIONS

This patent application is based on and claims priority pursuant to 35 U.S.C. § 119 (a) to Japanese Patent Application No. 2024-010951, filed on Jan. 29, 2024, in the Japan Patent Office, the entire disclosure of which is hereby incorporated by reference herein.

### BACKGROUND

### Technical Field

Embodiments of the present disclosure relate to an image forming apparatus.

### Related Art

An image forming apparatus of an electrophotographic method or an inkjet printing system includes, for example, a scanner unit, a controller unit, and a printer unit. The scanner unit acquires image data by scanning a document. The controller unit generates print data based on the image data. The printer unit forms an image based on the print data on a recording medium.

Some image forming apparatuses have a configuration for maintaining the functions even when a failure such as a breakdown occurs in the image forming apparatuses. For example, in certain types of image forming apparatuses, an external storage device is connected to the controller unit, which is the main body of an image processing apparatus, to back up the internal storage device. When a failure occurs in the internal storage device, the image forming apparatuses switch from the internal storage device to the external storage device to maintain the functions of the image forming apparatuses.

Further, some image forming apparatuses shift to an energy saving mode (a standby state) in which power consumption is lower than that in the normal mode when no operation is performed for a specified period of time or when receiving an instruction from an operator. When an instruction for copying is given to an image forming apparatus in the energy saving mode, the image forming apparatus shifts to the normal mode and performs a series of operations related to copying in the normal mode.

As described above, the image forming apparatuses switch to use the external storage device for the backup when there is a failure in the internal storage device. Consequently, when there is a failure in the controller unit itself, print data cannot be generated and copying cannot be performed. In the image forming apparatus that shifts to the energy saving mode, the controller unit cannot generate print data unless the energy saving mode is shifted to the normal mode. Consequently, copying cannot be performed in the energy saving mode.

### SUMMARY

In one aspect, an image forming apparatus includes an image reading device to read an image of a document to acquire image data, a printing device to print an image on a recording medium based on print data, and circuitry to communicate with the image reading device and the printing device via electrical interfaces and generate first print data based on the image data acquired by the image reading device in a first state. In a case of a second state in which the circuitry does not generate the first print data, the image reading device generates second print data based on the acquired image data. The printing device prints an image on a recording medium based on the first print data in a case of the first state, and prints an image on a recording medium based on the second print data in the case of the second state.

### BRIEF DESCRIPTION OF THE DRAWINGS

A more complete appreciation of embodiments of the present disclosure and many of the attendant advantages and features thereof can be readily obtained and understood from the following detailed description with reference to the accompanying drawings, wherein:

FIG. 1 is a schematic diagram illustrating an overall configuration of an image forming apparatus according to a first embodiment;

FIG. 2 is a block diagram illustrating a configuration of the image forming apparatus according to the first embodiment;

FIG. 3A is a diagram schematically illustrating the flow of data in a normal mode according to the first embodiment;

FIG. 3B is a diagram schematically illustrating the flow of data when a main controller has a failure according to the first embodiment;

FIG. 4 is a flowchart of the control performed by a scanner controller according to the first embodiment;

FIG. 5A is a flowchart of the connection process with a main controller according to the first embodiment;

FIG. 5B is a flowchart of the connection process with a printer controller according to the first embodiment;

FIG. 6 is a flowchart of the process during scanning according to the first embodiment;

FIG. 7 is a flowchart of the control performed by a main controller according to the first embodiment;

FIG. 8A is a flowchart of the control performed by a printer controller according to the first embodiment;

FIG. 8B is a flowchart of the process at a time of print data reception according to the first embodiment;

FIG. 9 is a schematic diagram illustrating an overall configuration of an image forming apparatus according to a second embodiment;

FIG. 10A is a diagram schematically illustrating the flow of data in a normal mode according to the second embodiment;

FIG. 10B is a diagram schematically illustrating the flow of data when a main controller has a failure according to the second embodiment;

FIG. 11 is a schematic diagram illustrating an overall configuration of an image forming apparatus according to a third embodiment;

FIG. 12A is a diagram schematically illustrating the flow of data in a normal mode according to the third embodiment; and

FIG. 12B is a diagram schematically illustrating the flow of data in an energy saving mode according to the third embodiment.

The accompanying drawings are intended to depict embodiments of the present disclosure and should not be interpreted to limit the scope thereof. The accompanying drawings are not to be considered as drawn to scale unless explicitly noted. Also, identical or similar reference numerals designate identical or similar components throughout the several views.

### DETAILED DESCRIPTION

In describing embodiments illustrated in the drawings, specific terminology is employed for the sake of clarity. However, the disclosure of this specification is not intended to be limited to the specific terminology so selected and it is to be understood that each specific element includes all technical equivalents that have a similar function, operate in a similar manner, and achieve a similar result.

Referring now to the drawings, embodiments of the present disclosure are described below. As used herein, the singular forms “a,” “an,” and “the” are intended to include the plural forms as well, unless the context clearly indicates otherwise.

### Overview of Image Forming Apparatus

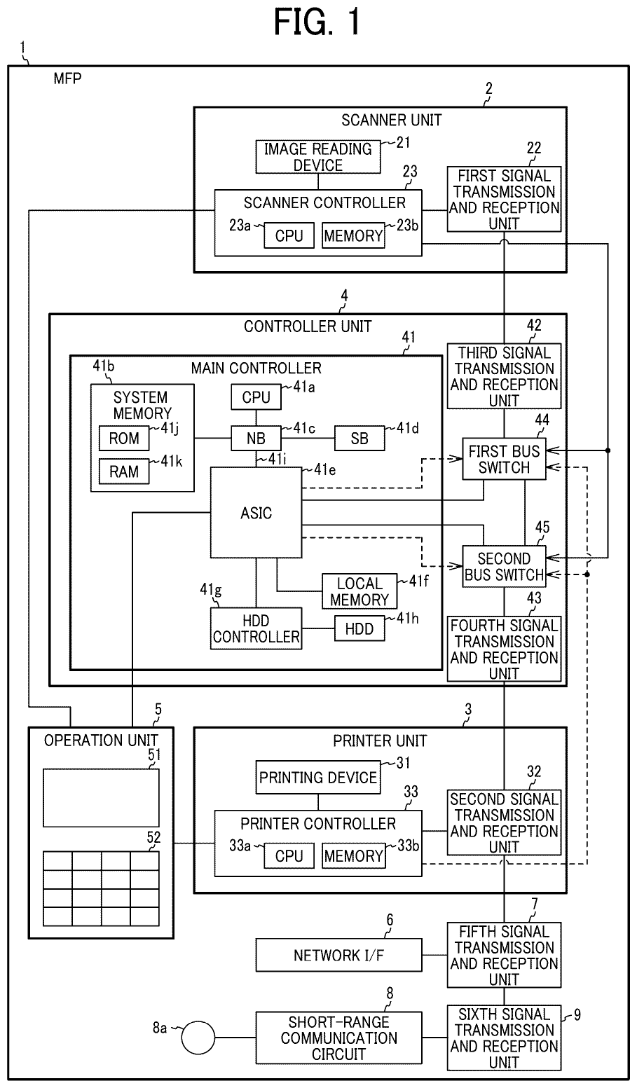

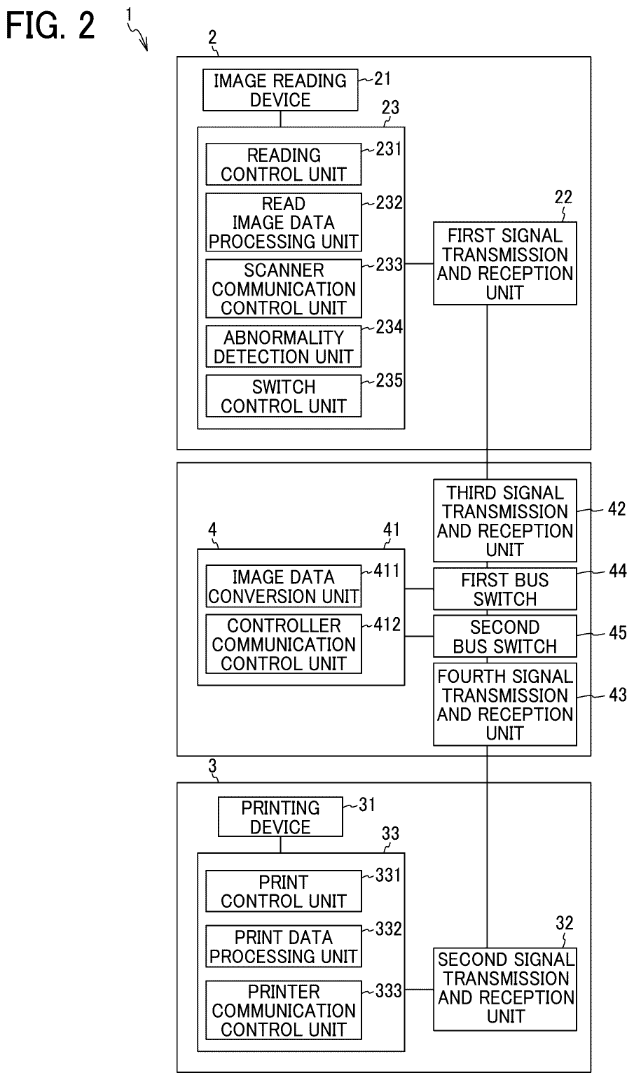

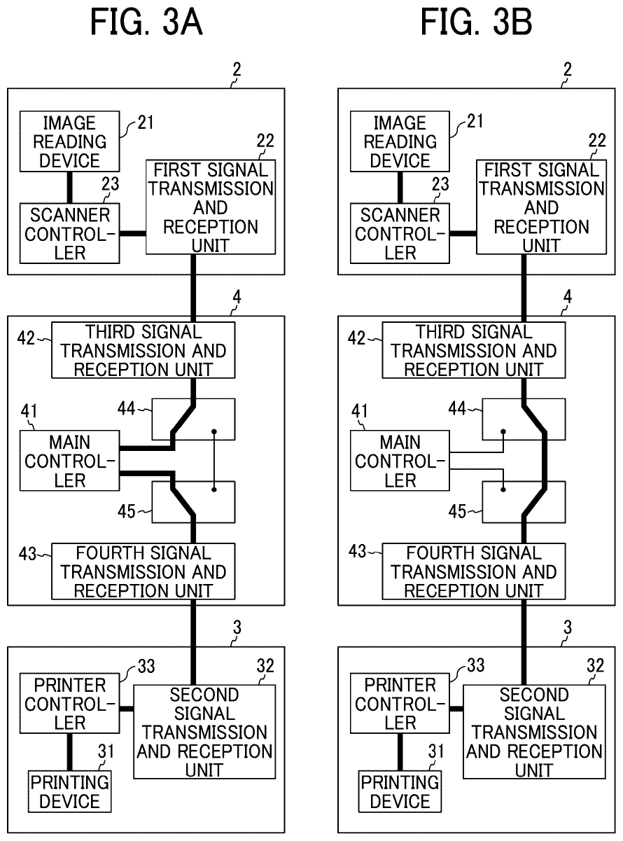

An overview of an image forming apparatus 1 is described below with reference to FIGS. 1 to 3B. FIG. 1 is a schematic diagram illustrating an overall configuration of the image forming apparatus 1 according to a first embodiment. FIG. 2 is a block diagram illustrating a configuration of the image forming apparatus 1 according to the first embodiment. FIG. 3A is a diagram schematically illustrating the flow of data in a normal mode according to the first embodiment. FIG. 3B is a diagram schematically illustrating the flow of data when a main controller has a failure according to the first embodiment. In the following description, a multifunction peripheral (MFP) is used as an example of the image forming apparatus 1. However, the image forming apparatus 1 is not limited to an MFP. Note that elements, types of elements, combinations of elements, shapes of elements, and relative positions of elements in the embodiments of the present disclosure are not intended to limit the scope of the present disclosure, but are merely examples of description unless otherwise specified.

The image forming apparatus 1 illustrated in FIGS. 1 and 2 includes a scanner unit 2, a printer unit 3, and a controller unit 4. The scanner unit 2 reads an image of a document to acquire scan data (read image data such as image data in a red, green, and blue (RGB) format). The printer unit 3 forms an image on a recording medium (e.g., a copy sheet). The controller unit 4 is communicably connected to the scanner unit 2 and the printer unit 3. The scanner unit 2 includes an image reading device 21, a first signal transmission and reception unit 22, and a scanner controller 23. The image reading device 21 reads an image of a document. The first signal transmission and reception unit 22 transmits and receives a signal to and from a third signal transmission and reception unit 42 included in the controller unit 4. The scanner controller 23 serves as the main controller of the scanner unit 2. The printer unit 3 includes a printing device 31, a second signal transmission and reception unit 32, and a printer controller 33. The printing device 31 prints an image on a recording medium. The second signal transmission and reception unit 32 transmits and receives a signal to and from a fourth signal transmission and reception unit 43 included in the controller unit 4. The printer controller 33 serves as the main controller of the printer unit 3.

The controller unit 4 includes the third signal transmission and reception unit 42, the fourth signal transmission and reception unit 43, a main controller 41, a first bus switch 44 (a path changing device), and a second bus switch 45 (a path changing device). The third signal transmission and reception unit 42 communicates with the first signal transmission and reception unit 22 included in the scanner unit 2. The fourth signal transmission and reception unit 43 communicates with the second signal transmission and reception unit 32 included in the printer unit 3. The main controller 41 serves as the main controller of the image forming apparatus 1. The first bus switch 44 is disposed between the third signal transmission and reception unit 42 and the main controller 41. The second bus switch 45 is disposed between the fourth signal transmission and reception unit 43 and the main controller 41. The first bus switch 44 connects the third signal transmission and reception unit 42 and the main controller 41 (an application-specific integrated circuit (ASIC) 41) to each other. The first bus switch 44 also connects the third signal transmission and reception unit 42 and the second bus switch 45 to each other. The second bus switch 45 connects the main controller 41 and the fourth signal transmission and reception unit 43 to each other. The second bus switch 45 also connects the first bus switch 44 and the fourth signal transmission and reception unit 43 to each other. Each of the first bus switch 44 and the second bus switch 45 can switch the connection destinations by, for example, a control signal from the scanner controller 23.

As illustrated in FIG. 3A, in a normal mode (the first state in which the controller unit 4 generates the first print data to be described later), the first bus switch 44 connects the third signal transmission and reception unit 42 and the main controller 41 to each other, and the second bus switch 45 connects the main controller 41 and the fourth signal transmission and reception unit 43 to each other. In response to an instruction to copy a document in the normal mode, the scanner controller 23 controls the image reading device 21 to read an image of the document. The scanner controller 23 (a detection device) communicates with the main controller 41 included in the controller unit 4 and detects whether the main controller 41 has a failure. The image reading device 21 reads the image of the document to acquire scan data (e.g., image data in the RGB format), and outputs the scan data to the scanner controller 23.

In the case where no failure is detected in the main controller 41, the scanner controller 23 outputs the scan data to the first signal transmission and reception unit 22. The scan data is input to the main controller 41 through the third signal transmission and reception unit 42 and the first bus switch 44. The main controller 41 generates the first print data based on the scan data. For example, the main controller 41 converts the scan data into image data in a cyan, magenta, yellow, and black (CMYK) format and executes edit processing such as page editing to generate the first print data. The first print data is input to the printer controller 33 through the second bus switch 45, the fourth signal transmission and reception unit 43, and the second signal transmission and reception unit 32. The printer controller 33 controls, based on the first print data, the printing device 31 to print an image on a recording medium.

As illustrated in FIG. 3B, in the case where a failure is detected in at least a part of the main controller 41, that is, in the case where it is determined that the main controller 41 is in the second state in which the first print data is not generated, the scanner controller 23 connects the first bus switch 44 and the second bus switch 45 to be communicable with each other. The scanner controller 23 also generates the second print data based on the scan data. For example, the scanner controller 23 converts the scan data into image data in the Joint Photographic Experts Group (JPEG) format and executes processing for making the image data printable by the printer unit 3 to generate the second print data. The second print data is input to the printer controller 33 through the first signal transmission and reception unit 22, the third signal transmission and reception unit 42, the first bus switch 44, the second bus switch 45, the fourth signal transmission and reception unit 43, and the second signal transmission and reception unit 32. In other words, the second print data is input to the printer controller 33 without passing through the main controller 41. The printer controller 33 controls, based on the second print data, the printing device 31 to print an image on a recording medium.

The image forming apparatus in the art having the copying function cannot maintain the copying function in a state where the controller unit cannot generate print data.

As can be understood from the above description, according to the image forming apparatus 1, the copying function can be maintained even in the second state in which the controller unit 4 does not generate print data.

### Details of Image Forming Apparatus

The configuration of the image forming apparatus 1 is described in detail below. As illustrated in FIG. 1, the image forming apparatus (MFP) 1 includes the scanner unit 2, the printer unit 3, the controller unit 4, an operation unit 5, a network interface (I/F) 6, a fifth signal transmission and reception unit 7, a short-range communication circuit 8, and a sixth signal transmission and reception unit 9. The hardware configuration of the image forming apparatus 1 is not limited to the configuration illustrated in FIG. 1.

### Scanner Unit

The image reading device 21 includes, for example, an exposure glass, an automatic document feeder (ADF), and a line image sensor. The image reading device 21 reads an image of a document placed on the front side of the exposure glass with the line image sensor that is movable along the sub-scanning direction on the back side of the exposure glass, and also reads a document fed by the ADF with the line image sensor. The line image sensor acquires scan data corresponding to the read document and outputs the scan data. The scan data output from the line image sensor is input to the scanner controller 23. The scan data is, for example, image data in the RGB format, but is not limited to image data in this format. The first signal transmission and reception unit 22 is, for example, a universal serial bus (USB) interface, but may be a communication interface of another standard.

The scanner controller 23 includes a central processing unit (CPU) 23a as a main processor and a memory 23b for storing programs for operating the CPU 23a and various data. As illustrated in FIG. 2, by the CPU 23a executing the programs stored in the memory 23b, the scanner controller 23 performs the respective functions of, for example, a reading control unit 231, a read image data processing unit 232, a scanner communication control unit 233, an abnormality detection unit 234, and a switch control unit 235. The reading control unit 231 controls the operation of the image reading device 21. The read image data processing unit 232 processes the scan data acquired by the image reading device 21. The scanner communication control unit 233 controls communication between the scanner unit 2, and the printer unit 3 and the controller unit 4. The abnormality detection unit 234 detects whether there is an abnormality in the controller unit 4. The switch control unit 235 controls the first bus switch 44 and the second bus switch 45 included in the controller unit 4.

The read image data processing unit 232 executes, for example, image processing such as error diffusion and gamma conversion on the input scan data. In addition, in the case of the first state in which the controller unit 4 can generate the first print data, the read image data processing unit 232 accumulates the scan data acquired by the image reading device 21 (line image sensor) and transmits the accumulated scan data in units of a predetermined data amount. The transmitted scan data is received by the controller unit 4, and the first print data is generated (described later). Further, in the case of the second state in which the controller unit 4 does not generate the first print data, the read image data processing unit 232 generates the second print data (e.g., print data including image data in the JPEG format) based on the scan data acquired by the image reading device 21 and transmits the second print data. The transmitted second print data is received by the printer unit 3.

### Printer Unit

The printing device 31 is a printer employing, for example, an electrophotographic method or an inkjet printing system, but is not limited to these types. The printing device 31 is described below, which is given by way of example as a printer employing an electrophotographic method. The printing device 31 employing an electrophotographic method prints an image (i.e., forms an image) on a recording medium through the following process. First, a photoconductor drum serving as an image bearer is uniformly charged, and a laser beam or the like is irradiated onto the surface of the photoconductor drum to form an electrostatic latent image. Subsequently, toner is caused to adhere to the electrostatic latent image to form a toner image, and the toner image is transferred to a recording medium and fixed. By fixing the toner image, an image is printed on the recording medium. The second signal transmission and reception unit 32 is, for example, a USB interface, but may be a communication interface of another standard.

Like the scanner controller 23, the printer controller 33 also includes a CPU 33a as a main processor and a memory 33b for storing programs for operating the CPU 33a and various data. As illustrated in FIG. 2, by the CPU 33a executing the programs stored in the memory 33b, the printer controller 33 performs the respective functions of, for example, a print control unit 331, a print data processing unit 332, and a printer communication control unit 333. The print control unit 331 controls the operation of the printing device 31. The print data processing unit 332 executes image processing such as error diffusion and gamma conversion on each type of print data (such as the first print data or the second print data) transmitted from the controller unit 4 or the scanner controller 23. The printer communication control unit 333 controls communication between the printer unit 3, and the scanner unit 2 and the controller unit 4.

### Controller Unit

As illustrated in FIG. 1, the controller unit 4 includes the main controller 41, the third signal transmission and reception unit 42, the fourth signal transmission and reception unit 43, the first bus switch 44, and the second bus switch 45.

The main controller 41 controls, for example, drawing, communication, and input in the image forming apparatus 1. The main controller 41 includes a CPU 41a as a main processor, a system memory 41b, a north bridge (NB) 41c, a south bridge (SB) 41d, the ASIC 41, a local memory 41f as a storage area, a hard disk drive (HDD) controller 41g, and an HDD 41h as a storage area. The NB 41c and the ASIC 41 are connected via an accelerated graphics port (AGP) bus 41i. However, the configuration of the main controller 41 is not limited to the configuration described above. For example, two or more components such as the CPU 41a, the NB 41c, and the SB 41d may be implemented by a system on chip (SoC). In such a case, the SoC and the ASIC 41 may be connected via a PCI-EXPRESS bus.

The CPU 41a is a controller that controls the entire operation of the image forming apparatus 1. The NB 41c is a bridge for connecting the CPU 41a with the system memory 41b, the SB 41d, and the AGP bus 41i. The NB 41c includes a memory controller for controlling the reading and writing of various data from and to the system memory 41b, a peripheral component interconnect (PCI) master, and an AGP target.

The system memory 41b includes a read-only memory (ROM) 41j as a memory that stores programs and data for implementing various functions of the main controller 41. The system memory 41b further includes a random-access memory (RAM) 41k used as a memory to load the programs and the data, or as a drawing memory that stores drawing data for printing. For the distribution, the programs stored in the ROM 41j may be stored in any computer-readable recording medium, such as a compact disc-read only memory (CD-ROM), a compact disc-recordable (CD-R), or a digital versatile disc (DVD), in a file format installable or executable by a computer.

The SB 41d is a bridge for connecting the NB 41c to PCI devices and peripheral devices. The ASIC 41 is an integrated circuit (IC) dedicated to image processing and includes hardware elements for image processing. The ASIC 41 serves as a bridge to connect the AGP bus 41i, the HDD controller 41g, and the local memory 41f to each other. The ASIC 41 includes a PCI target, an AGP master, an arbiter (ARB) as a central processor of the ASIC 41, a memory controller to control the local memory 41f, a plurality of direct memory access controllers (DMACs), and a transfer unit. For example, the DMACs convert coordinates of image data with hardware logic to rotate an image based on the image data. The transfer unit transfers data between the scanner unit 2 and the printer unit 3. In the present embodiment, to the ASIC 41, USB interfaces (the third signal transmission and reception unit 42 and the fourth signal transmission and reception unit 43) are connected via a bus and bus switches (the first bus switch 44 and the second bus switch 45). Another type of interface such the Institute of Electrical and Electronics Engineers (IEEE) 1394 interface may be connected to the ASIC 41c.

The local memory 41f is a memory used as a buffer for image data to be copied or a code buffer. The HDD 41h is a storage device that stores image data, font data for printing, and form data. The HDD controller 41g controls the reading and writing of data from and to the HDD 41h under the control of the CPU 41a.

The AGP bus 41i is a bus interface for a graphics accelerator card, which has been proposed to accelerate graphics processing. Through directly accessing the system memory 41b by high-throughput, the speed of the graphics accelerator card increases. The local memory 41f is optionally provided.

The third signal transmission and reception unit 42 is, for example, a USB interface, and is communicably connected to the first signal transmission and reception unit 22 included in the scanner unit 2. The fourth signal transmission and reception unit 43 is also, for example, a USB interface, and is communicably connected to the second signal transmission and reception unit 32 included in the printer unit 3. The third signal transmission and reception unit 42 and the fourth signal transmission and reception unit 43 may be communication interfaces of other standards.

The first bus switch 44 is disposed between the third signal transmission and reception unit 42 and the main controller 41, and between the third signal transmission and reception unit 42 and the second bus switch 45. The first bus switch 44 connects the third signal transmission and reception unit 42 and the main controller 41 to be communicable with each other, and connects the third signal transmission and reception unit 42 and the second bus switch 45 to be communicable with each other. For example, the first bus switch 44 connects the third signal transmission and reception unit 42 and the ASIC 41 included in the main controller 41 to be communicable with each other in the first state in which the main controller 41 can generate the first print data. The first bus switch 44 also connects the third signal transmission and reception unit 42 and the second bus switch 45 to be communicable with each other in the second state in which the main controller 41 does not generate the first print data.

The second bus switch 45 is disposed between the main controller 41 and the fourth signal transmission and reception unit 43, and between the first bus switch 44 and the fourth signal transmission and reception unit 43. The second bus switch 45 connects the main controller 41 and the fourth signal transmission and reception unit 43 to be communicable with each other, and connects the first bus switch 44 and the fourth signal transmission and reception unit 43 to be communicable with each other. For example, the second bus switch 45 connects the ASIC 41 included in the main controller 41 and the fourth signal transmission and reception unit 43 to be communicable with each other in the first state, and connects the first bus switch 44 and the fourth signal transmission and reception unit 43 to be communicable with each other in the second state.

As illustrated in FIG. 2, by the CPU 41a executing the programs stored in the system memory 41b, the main controller 41 performs the respective functions of an image data conversion unit 411 and a controller communication control unit 412. The image data conversion unit 411 converts scan data into the first print data. The controller communication control unit 412 controls communication between the controller unit 4, and the scanner unit 2 and the printer unit 3. The image data conversion unit 411 converts, for example, the scan data into image data in the CMYK format, and performs page editing such as page order switching for saddle stitch printing or aggregate printing (printing multiple pages per sheet) as necessary to generate the first print data. Accordingly, the image data conversion unit 411 may also be referred to as a first print data generation unit that generates the first print data. For example, the controller communication control unit 412 controls the third signal transmission and reception unit 42 to receive the scan data transmitted from the scanner unit 2, and controls the fourth signal transmission and reception unit 43 to transmit the first print data generated by the image data conversion unit 411 (first print data generation unit) to the printer unit 3.

### Operation Unit, Network I/F, and Short-Range Communication Circuit

The operation unit 5 illustrated in FIG. 1 receives input from an operator and displays various images and messages to be input. The operation unit 5 includes a panel display 51 and an operation panel 52. The panel display 51 is, for example, a touch panel that displays current settings or a selection screen and receives input from the operator. The operation panel 52 includes, for example, a numeric keypad, a start key, and an application switch key. The numeric keypad receives assigned values of image forming parameters such as an image density parameter. The start key receives an instruction to start copying. The application switch key receives an instruction to switch functions performed by the image forming apparatus 1. The operation unit 5 is communicably connected to the ASIC 41c included in the main controller 41, the scanner controller 23 included in the scanner unit 2, and the printer controller 33 included in the printer unit 3. The operation unit 5 may be connected to the SB 41d instead of the ASIC 41c.

In response to an instruction to select a specific application through the operation panel 52 by use of, for example, the application (or mode) switch key, the image forming apparatus 1 selectively performs a document server function, a copying function, a printing function, and a facsimile communication function. When the document server function is selected, an operation mode switches to a document box mode. With selection of the copying function, the operation mode switches to a copy mode. With selection of the printing function, the operation mode switches to a printer mode. With selection of the facsimile communication function, the operation mode switches to a facsimile mode. The panel display 51 may be configured with a display device such as a liquid crystal display (LCD) for displaying various information or a light-emitting diode (LED) for displaying an operating state by being turned on or off. In the case where the panel display 51 is configured with a touch panel, the operation panel 52 may be omitted.

The network I/F 6, which may be implemented by an interface circuit, is an interface that controls the communication of data through a communication network. In the present embodiment, the network I/F 6 is connected to the second signal transmission and reception unit 32 via the fifth signal transmission and reception unit 7 configured with, for example, a USB interface. The short-range communication circuit 8 is provided with an antenna 8a used for transmitting and receiving data. The short-range communication circuit 8 is a communication circuit in compliance with, for example, the near field communication (NFC) or BLUETOOTH. In the present embodiment, the short-range communication circuit 8 is connected to the fifth signal transmission and reception unit 7 via the sixth signal transmission and reception unit 9 configured with, for example, a USB interface. In the present embodiment, the network I/F 6 and the short-range communication circuit 8 are connected using the USBs, but the configuration is not limited thereto. For example, the network I/F 6 and the short-range communication circuit 8 may be connected to the ASIC 41 included in the main controller 41 via a PCI bus.

Operation under Normal Operating Conditions

With reference to FIGS. 1 to 3B, an operation performed by the image forming apparatus 1 according to the present embodiment is described below. For example, when the operator operates the operation panel 52 or the panel display 51 (touch panel) of the operation unit 5 to select the copying function and then instructs copying, a copy command is transmitted from the operation unit 5 to the scanner controller 23, the printer controller 33, and the main controller 41.

The scanner controller 23 starts a communication process with the main controller 41. At this time, the scanner controller 23 functions as the abnormality detection unit 234, and detects whether there is an abnormality in the main controller 41. For example, in the case where the scanner controller 23 establishes communication with the main controller 41 and does not receive a notification from the main controller 41 that there is an abnormality in a part of the main controller 41 such as the HDD 41h or the local memory 41f, the scanner controller 23 determines that there is no abnormality in the main controller 41. The manner of detection whether there is an abnormality in the main controller 41 is not limited to this example.

In the case where the scanner controller 23 determines that there is no abnormality in the main controller 41, the scanner controller 23 functions as the reading control unit 231, and controls the image reading device 21 to read an image of a document. Subsequently, the scanner controller 23 functions as the scanner communication control unit 233, and transmits the scan data acquired by the image reading device 21 to the controller unit 4.

As illustrated in FIG. 3A, in the case where it is determined that there is no abnormality in the main controller 41, the first bus switch 44 connects the third signal transmission and reception unit 42 and the main controller 41 (ASIC 41c) to each other. In this case, the main controller 41 functions as the controller communication control unit 412, and receives the scan data transmitted from the scanner controller 23. Subsequently, the main controller 41 functions as the image data conversion unit 411. For example, the main controller 41 executes image processing such as error diffusion and gamma conversion on the input scan data, converts the scan data after the image processing into data in the CMYK format, and further executes edit processing such as page editing to generate the first print data. Then, the main controller 41 functions again as the controller communication control unit 412, and transmits the first print data to the printer unit 3.

In the case where it is determined that there is no abnormality in the main controller 41, the second bus switch 45 connects the main controller 41 (ASIC 41c) and the fourth signal transmission and reception unit 43 to each other. The printer controller 33 functions as the printer communication control unit 333, and receives the first print data transmitted by the main controller 41. Subsequently, the printer controller 33 functions as the print data processing unit 332, and executes, on the first print data, processing required to cause the printing device 31 to perform a printing operation based on the first print data. Then, the printer controller 33 functions as the print control unit 331, and controls, based on the first print data after the processing, the operation of the printing device 31 to print an image on a recording medium.

### Operation When Abnormality Is Detected

The scanner controller 23 functions as the abnormality detection unit 234 after starting the communication process with the main controller 41. For example, in the case where the scanner controller 23 cannot establish communication with the main controller 41 or receives a notification from the main controller 41 that there is an abnormality in a part of the main controller 41 such as the HDD 41h or the local memory 41f, the scanner controller 23 determines that there is an abnormality in a part of the main controller 41.

As illustrated in FIG. 3B, in the case where it is determined that there is an abnormality in at least a part of the main controller 41, the scanner controller 23 functions as the switch control unit 235, and connects the first bus switch 44 and the second bus switch 45 to each other. In the controller unit 4, since the first bus switch 44 and the second bus switch 45 are connected to each other, the third signal transmission and reception unit 42 and the fourth signal transmission and reception unit 43 are connected to each other without passing through the main controller 41. In other words, the scanner unit 2 and the printer unit 3 are connected to each other through a bus in the controller unit 4 so as to be communicable with each other.

Even when it is determined that there is an abnormality in at least a part of the main controller 41, the scanner controller 23 functions as the reading control unit 231, and controls the image reading device 21 to read the image of the document. Subsequently, the scanner controller 23 functions as the read image data processing unit 232. For example, the scanner controller 23 executes image processing such as error diffusion and gamma conversion on the input scan data (image data in the RGB format), converts the scan data after the image processing into data in the JPEG format, and further executes processing for making the data printable by the printer unit 3 to generate the second print data. Then, the scanner controller 23 functions as the scanner communication control unit 233, and transmits the second print data to the controller unit 4.

As described above, since the scanner unit 2 and the printer unit 3 are communicably connected to each other, the second print data is transmitted to the printer unit 3. The printer controller 33 functions as the printer communication control unit 333, and receives the second print data transmitted by the scanner controller 23. Then, the printer controller 33 functions as the print data processing unit 332, and executes processing such as error diffusion and gamma conversion on the second print data. Subsequently, the printer controller 33 functions as the print control unit 331, and controls, based on the second print data after the processing, the operation of the printing device 31 to print an image on a recording medium.

As can be understood from the above description, according to the image forming apparatus 1 of the present embodiment, in the case where there is an abnormality in at least a part of the controller unit 4, the controller unit 4 cannot perform advanced editing, but maintains a minimum copying function.

### Specific Example of Control

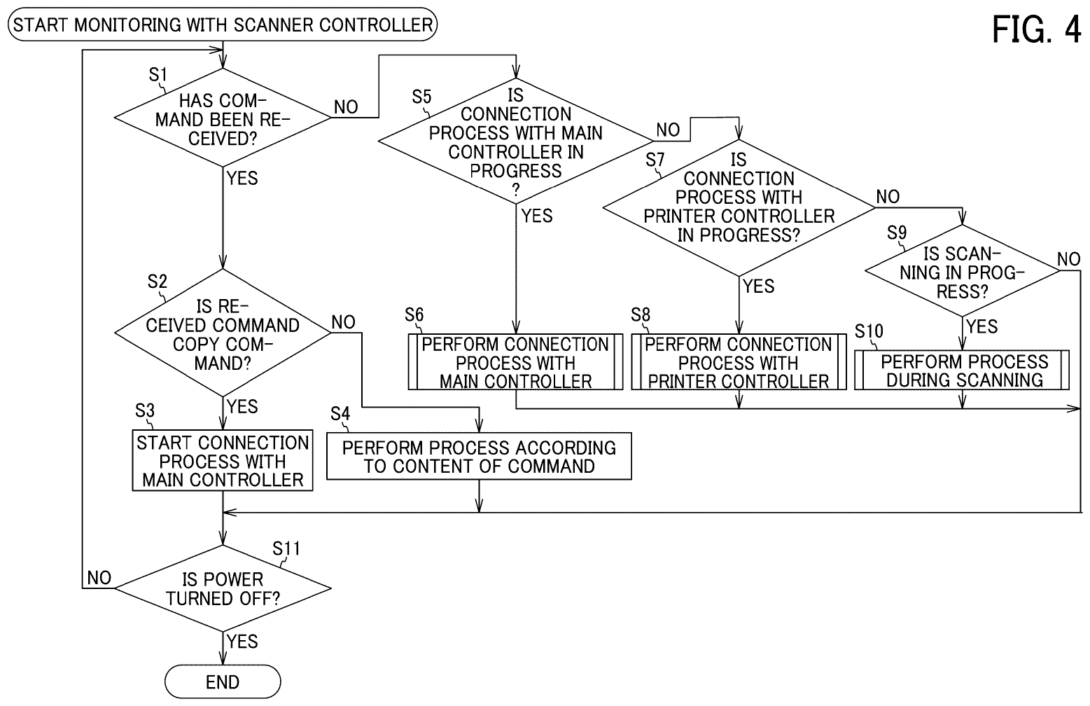

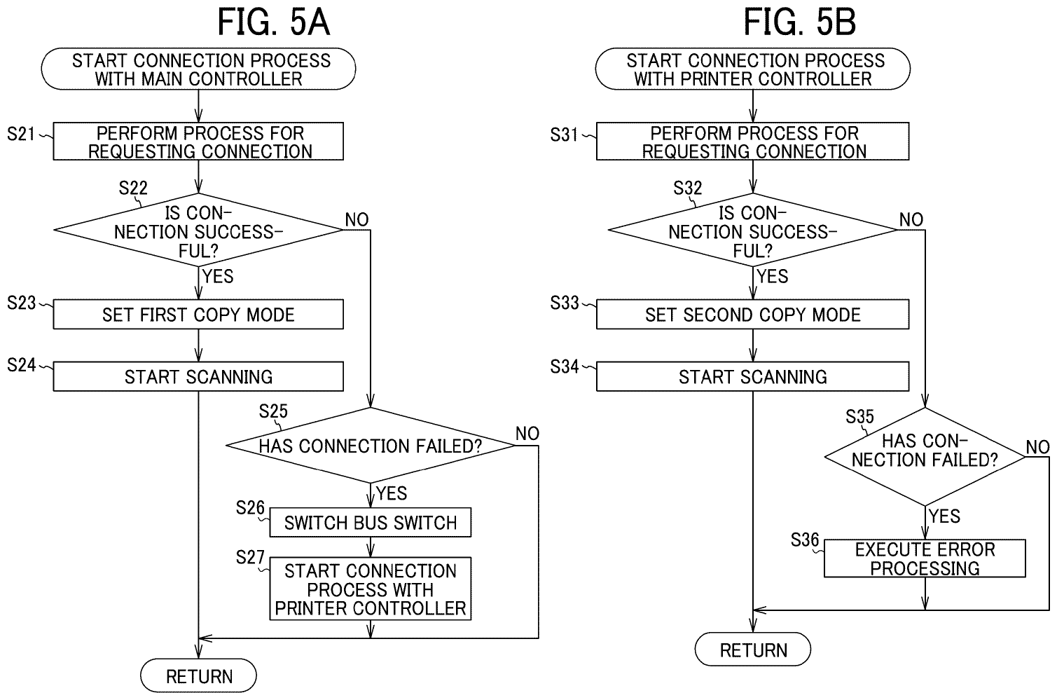

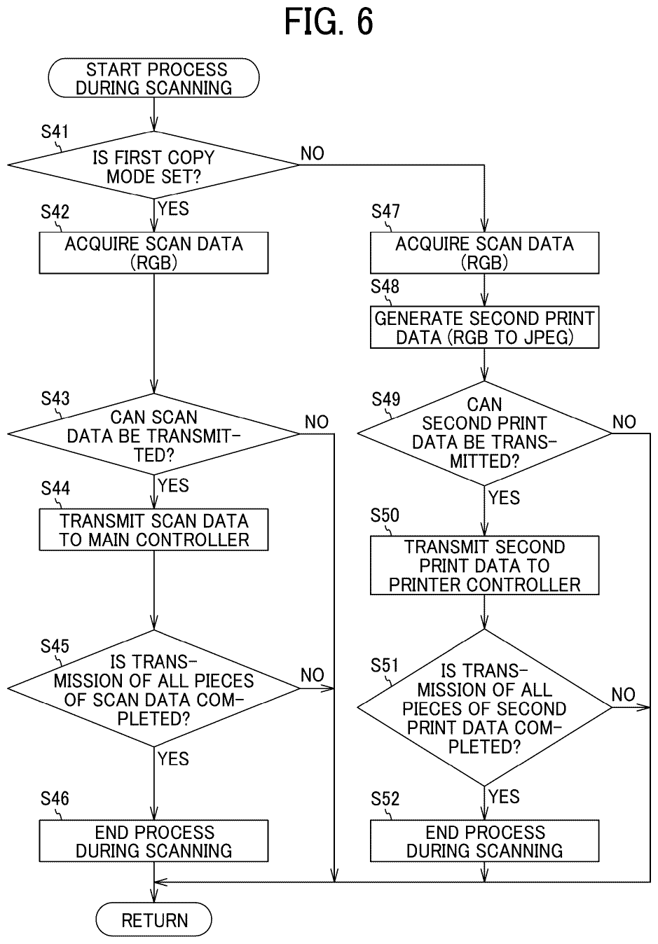

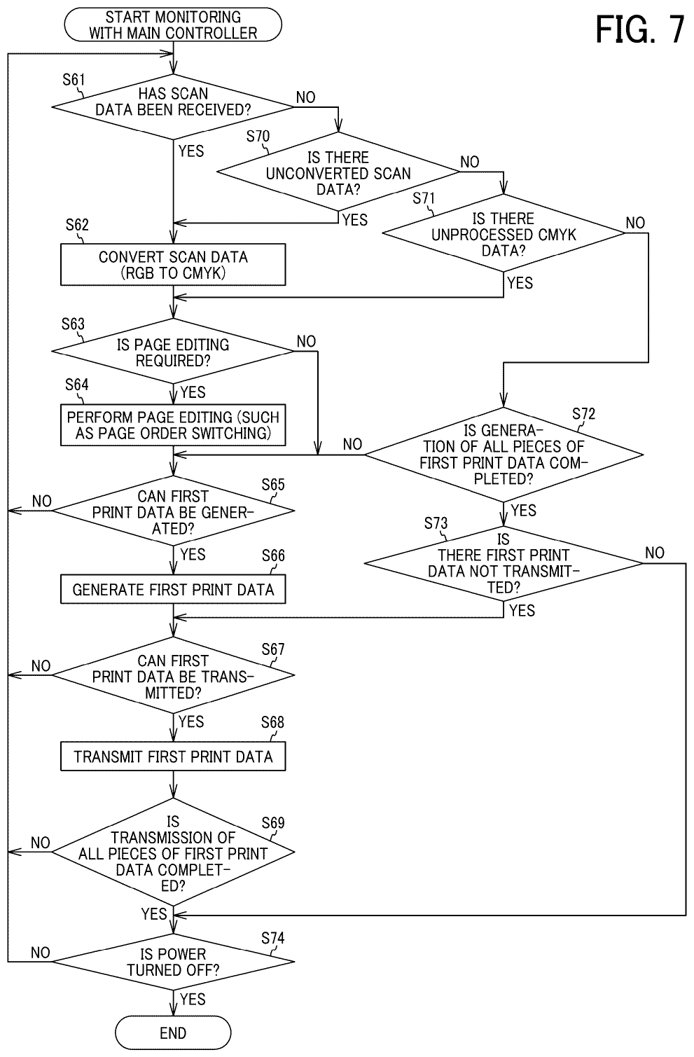

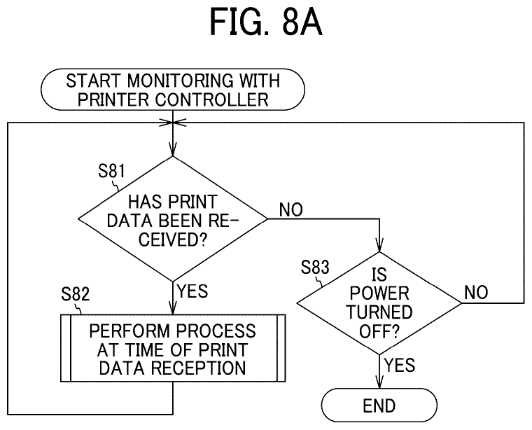

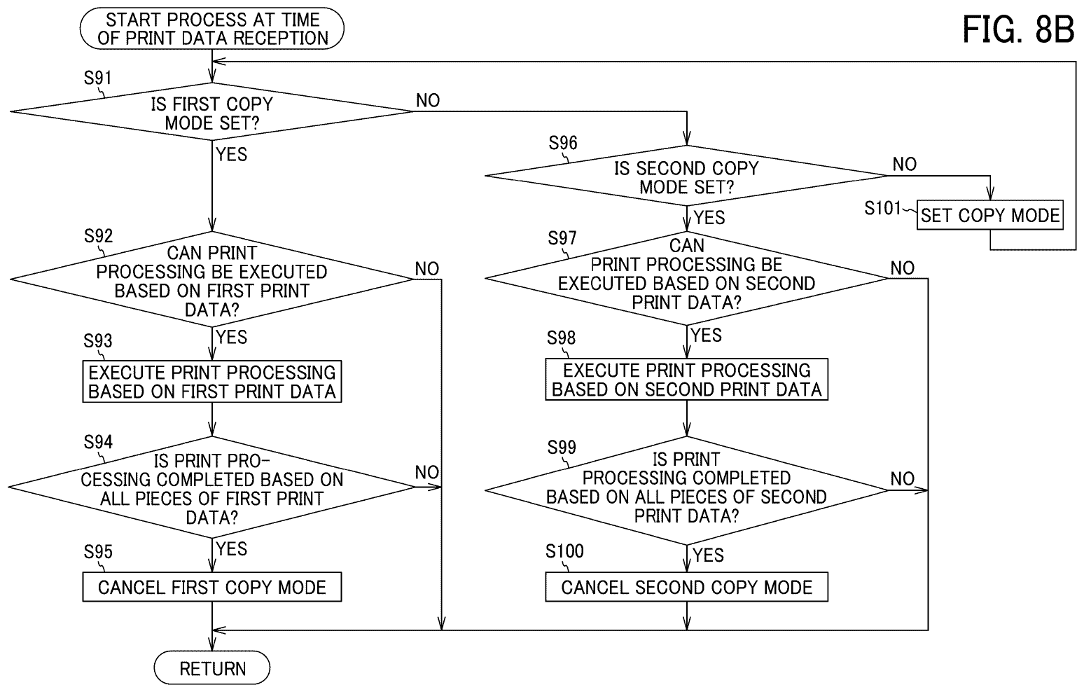

A specific example of control is described below. FIG. 4 is a flowchart of the control performed by the scanner controller 23 according to the first embodiment. FIG. 5A is a flowchart of the connection process with the main controller 41 according to the first embodiment. FIG. 5B is a flowchart of the connection process with the printer controller 33 according to the first embodiment. FIG. 6 is a flowchart of the process during scanning according to the first embodiment. FIG. 7 is a flowchart of the control performed by the main controller 41 according to the first embodiment. FIG. 8A is a flowchart of the control performed by the printer controller 33 according to the first embodiment. FIG. 8B is a flowchart of the process at the time of print data reception according to the first embodiment.

### Control Performed by Scanner Controller

In step S1, the scanner controller 23 monitors whether a command has been received from the operation unit 5. In the case where the command has been received (YES in step S1), the scanner controller 23 determines whether the received command is a copy command in step S2. In the case where the received command is determined to be a copy command (YES in step S2), the scanner controller 23 starts a connection process with the main controller 41 in step S3. In the case where the command is determined not to be a copy command (NO in step S2), the scanner controller 23 performs a process in accordance with the content of the command in step S4.

In the case where the command has not been received (NO in step S1), the scanner controller 23 determines whether the connection process with the main controller 41 is in progress in step S5. For example, in the case where the scanner controller 23 starts the connection process with the main controller 41 in step S3 or the process of step S6 to be described later is not completed, the scanner controller 23 determines that the connection process with the main controller 41 is in progress (YES in step S5), and shifts to the process of step S6. In step S6, the scanner controller 23 performs the connection process with the main controller 41.

In the connection process with the main controller 41 illustrated in FIG. 5A, the scanner controller 23 performs a process for requesting a connection to the main controller 41 in step S21. In step S22, the scanner controller 23 determines whether the connection with the main controller 41 is successful. In other words, the scanner controller 23 determines whether a signal transmission path (first path) is formed between the third signal transmission and reception unit 42 and the fourth signal transmission and reception unit 43 passing through the main controller 41 in the controller unit 4 as described with reference to FIG. 3A. In the case where the scanner controller 23 determines that the connection with the main controller 41 is successful (YES in step S22), the scanner controller 23 sets the first copy mode in step S23. In step S24, the scanner controller 23 controls the image reading device 21 to start scanning the document. The first copy mode is a mode in which, for example, there is no abnormality in the main controller 41 and a normal copying operation can be performed. In other words, the first copy mode is a state under normal operating conditions. As will be described later, the main controller 41 generates the first print data in the first copy mode and transmits the first print data to the printer controller 33.

On the other hand, in the case where the scanner controller 23 determines that the connection with the main controller 41 is not successful (NO in step S22), in step S25, the scanner controller 23 determines whether the connection with the main controller 41 has failed, in other words, whether there is a failure in at least a part of the main controller 41. In the case where the scanner controller 23 determines that the connection with the main controller 41 has not failed (NO in step S25), the scanner controller 23 ends the process of the current cycle and starts the process of the next cycle (return). On the other hand, in the case where the scanner controller 23 determines that the connection with the main controller 41 has failed (YES in step S25), the scanner controller 23 performs the switching processes of the first bus switch 44 and the second bus switch 45 in step S26. For example, as described with reference to FIG. 3B, the scanner controller 23 connects the first bus switch 44 and the second bus switch 45 to each other. Thus, in the controller unit 4, a signal transmission path (second path) is formed between the third signal transmission and reception unit 42 and the fourth signal transmission and reception unit 43 without passing through the main controller 41. After performing the switching processes of the first bus switch 44 and the second bus switch 45, the scanner controller 23 starts a connection process with the printer controller 33 in step S27.

As illustrated in FIG. 4, in the case where the scanner controller 23 does not receive a command in the process of step S1 (NO in step S1) and determines that the connection process with the main controller 41 is not in progress in the process of step S5 (NO in step S5), the scanner controller 23 determines whether the connection process with the printer controller 33 is in progress in step S7. For example, in the case where the scanner controller 23 starts the connection process with the printer controller 33 in step S27 (see FIG. 5A) or the process of step S8 to be described later is not completed, the scanner controller 23 determines that the connection process with the printer controller 33 is in progress (YES in step S7), and shifts to the process of step S8. In step S8, the scanner controller 23 performs the connection process with the printer controller 33.

In the connection process with the printer controller 33 illustrated in FIG. 5B, the scanner controller 23 performs a process for requesting a connection to the printer controller 33 in step S31. In step S32, the scanner controller 23 determines whether the connection with the printer controller 33 is successful. In the case where the scanner controller 23 determines that the connection with the printer controller 33 is successful (YES in step S32), the scanner controller 23 sets the second copy mode in step S33. In step S34, the scanner controller 23 controls the image reading device 21 to start scanning the document. The second copy mode is a mode in which, for example, there is an abnormality in at least a part of the main controller 41 and a normal copying operation cannot be performed. The main controller 41 does not generate the first print data in the second copy mode.

On the other hand, in the case where the scanner controller 23 determines that the connection with the printer controller 33 is not successful (NO in step S32), in step S35, the scanner controller 23 determines whether the connection with the printer controller 33 has failed. In the case where the scanner controller 23 determines that the connection with the printer controller 33 has not failed (NO in step S35), the scanner controller 23 ends the process of the current cycle and starts the process of the next cycle (return). On the other hand, in the case where the scanner controller 23 determines that the connection with the printer controller 33 has failed (YES in step S35), the scanner controller 23 determines that copying cannot be performed and executes error processing in step S36. In the error processing, the scanner controller 23 transmits, for example, to the operation unit 5, a command for displaying an error message on the panel display 51.

As illustrated in FIG. 4, in the case where the scanner controller 23 does not receive a command in the process of step S1 (NO in step S1), determines that the connection process with the main controller 41 is not in progress in the process of step S5 (NO in step S5), and determines that the connection process with the printer controller 33 is not in progress in the process of step S7 (NO in step S7), the scanner controller 23 determines whether scanning of the document is in progress in step S9. For example, in the case where the scanner controller 23 starts scanning in step S24 of FIG. 5A or step S34 of FIG. 5B or the process of step S10 to be described later is not completed, the scanner controller 23 determines that scanning of the document is in progress (YES in step S9), and shifts to the process of step S10. In step S10, the scanner controller 23 performs the process during scanning.

In the process during scanning illustrated in FIG. 6, the scanner controller 23 determines whether the first copy mode is set in step S41. For example, in the case where the first copy mode is set in the above-described process of step S23, the scanner controller 23 determines that the first copy mode is set. In the case where the second copy mode is set in the above-described process of step S33, the scanner controller 23 determines that the first copy mode is not set.

In the case where the scanner controller 23 determines that the first copy mode is set (YES in step S41), the scanner controller 23 acquires scan data from the image reading device 21 in step S42. The scanner controller 23 accumulates the acquired scan data in the memory 23b. In step S43, the scanner controller 23 determines whether the scan data can be transmitted to the main controller 41. For example, in the case where the amount of the scan data accumulated in the memory 23b reaches a predetermined data amount required for transmission, the scanner controller 23 determines that the scan data can be transmitted.

In the case where the scanner controller 23 determines that the scan data cannot be transmitted (NO in step S43), the scanner controller 23 ends the process of the current cycle and starts the process of the next cycle (return). On the other hand, in the case where the scanner controller 23 determines that the scan data can be transmitted (YES in step S43), the scanner controller 23 transmits the scan data to the main controller 41 in step S44. In step S45, the scanner controller 23 determines whether transmission of all pieces of scan data required for copying to the main controller 41 is completed. In the case where the scanner controller 23 determines that the transmission is not completed (NO in step S45), the scanner controller 23 ends the process of the current cycle and starts the process of the next cycle (return). In the case where the scanner controller 23 determines that the transmission is completed (YES in step S45), the scanner controller 23 ends the process during scanning in step S46, and starts the process of the next cycle (return).

In the case where the scanner controller 23 determines that the first copy mode is not set (NO in step S41), in step S47, the scanner controller 23 acquires the scan data from the image reading device 21 and accumulates the scan data in the memory 23b. In step S48, the scanner controller 23 generates the second print data printable by the printer unit 3 based on the scan data. In the present embodiment, the generated second print data is accumulated in, for example, the memory 23b. In step S49, the scanner controller 23 determines whether the second print data can be transmitted to the main controller 41. For example, in the case where the amount of the second print data accumulated in the memory 23b reaches a predetermined data amount required for transmission, the scanner controller 23 determines that the second print data can be transmitted.

In the case where the scanner controller 23 determines that the second print data cannot be transmitted (NO in step S49), the scanner controller 23 ends the process of the current cycle and starts the process of the next cycle (return). On the other hand, in the case where the scanner controller 23 determines that the second print data can be transmitted (YES in step S49), the scanner controller 23 transmits the second print data to the printer controller 33 in step S50. In step S51, the scanner controller 23 determines whether transmission of all pieces of second print data required for copying to the printer controller 33 is completed. In the case where the scanner controller 23 determines that the transmission is not completed (NO in step S51), the scanner controller 23 ends the process of the current cycle and starts the process of the next cycle (return). In the case where the scanner controller 23 determines that the transmission is completed (YES in step S51), the scanner controller 23 ends the process during scanning in step S52, and starts the process of the next cycle (return).

As illustrated in FIG. 4, in step S11, the scanner controller 23 repeatedly performs the above-described processes until the power supply of the image forming apparatus 1 is turned off.

### Control Performed by Main Controller

As illustrated in FIG. 7, in step S61, the main controller 41 monitors whether scan data has been received from the scanner unit 2. In the case where the scan data has been received (YES in step S61), the main controller 41 accumulates the received scan data in a memory such as the local memory 41f or the HDD 41h. In the following description, the local memory 41f and the HDD 41h may be collectively referred to as memories, and one thereof is referred to as a memory. In step S62, the main controller 41 converts the scan data. For example, image data in the RGB format, which is the scan data, is converted into image data in the CMYK format. The image data in the CMYK format is accumulated in the memory.

In step S63, the main controller 41 determines whether page editing such as page order switching for saddle stitch printing or aggregate printing needs to be performed. In the case where the page editing is determined to need to be performed (YES in step S63), the main controller 41 performs the page editing in step S64. The determination of whether the page editing needs to be performed can be made based on, for example, a copy command transmitted by the operation unit 5. On the other hand, in the case where the page editing is determined not to need to be performed (NO in step S63), the main controller 41 does not perform the page editing in step S64. In step S65, the main controller 41 determines whether the first print data can be generated. For example, in the case where the amount of the image data in the CMYK format accumulated in the memory is equal to or greater than a specified amount, the main controller 41 determines that the first print data can be generated. In the case where the main controller 41 determines that the first print data can be generated (YES in step S65), the main controller 41 generates the first print data in step S66. The generated first print data is accumulated in the memory or the like. On the other hand, in the case where the main controller 41 determines that the first print data cannot be generated (NO in step S65), the main controller 41 ends the process of the current cycle and starts the process of the next cycle (that is, shifts to the process of step S61).

In step S67, the main controller 41 determines whether the first print data can be transmitted. For example, in the case where the amount of the first print data accumulated in the memory is equal to or greater than a specified amount, the main controller 41 determines that the first print data can be transmitted. In the case where the main controller 41 determines that the first print data can be transmitted (YES in step S67), the main controller 41 transmits the first print data to the printer unit 3 in step S68. In step S69, the main controller 41 determines whether transmission of all pieces of the first print data is completed. In the case where the main controller 41 determines that the transmission is not completed (NO in step S69), the main controller 41 ends the process of the current cycle and starts the process of the next cycle (that is, shifts to the process of step S61). On the other hand, in the case where the main controller 41 determines that the transmission is completed (YES in S69), the main controller 41 shifts to the process of step S74, which will be described later.

In the case where the scan data has not been received in the above-described process of step S61 (NO is step S61), the main controller 41 determines whether there is unconverted scan data in step S70. In the case where the main controller 41 determines that there is unconverted scan data (YES in step S70), the main controller 41 shifts to the process of step S62. The main controller 41 perform the process of converting the scan data in step S62 and the processes of subsequent steps. In the case where the main controller 41 determines that there is no unconverted scan data (NO in step S70), the main controller 41 shifts to the process of step S71. In step S71, the main controller 41 determines whether there is unprocessed CMYK data. In the case where the main controller 41 determines that there is unprocessed CMYK data (YES in S71), the main controller 41 shifts to the process of step S63. The main controller 41 performs the process of determining whether page editing needs to be performed in step S63 and the processes of subsequent steps.

In the case where the main controller 41 determines that there is no unprocessed CMYK data (NO in step S71), the main controller 41 shifts to the process of step S72. In step S72, the main controller 41 determines whether generation of all pieces of the first print data is completed. In the case where the main controller 41 determines that the generation is not completed (NO in step S72), the main controller 41 shifts to the process of step S65. In step S65, the main controller 41 determines whether the first print data can be generated. In the case where the main controller 41 determines that the generation is completed (YES in step S72), the main controller 41 shifts to the process of step S73. In step S73, the main controller 41 determines whether there is any piece of first print data that has not been transmitted. In the case where the main controller 41 determines that there are one or more pieces of first print data that have not been transmitted (YES in step S73), the main controller 41 shifts to the process of step S67. In step S67, the main controller 41 determines whether the first print data can be transmitted. On the other hand, in the case where the main controller 41 determines that there is no piece of first print data that has not been transmitted (NO in step S73), the main controller 41 shifts to the process of step S74. In step S74, the main controller 41 repeatedly performs the above-described processes until the power supply of the image forming apparatus 1 is turned off.

### Control Performed by Printer Controller

As illustrated in FIG. 8A, in step S81, the printer controller 33 monitors whether print data (the first print data or the second print data) has been received from the controller unit 4 or the scanner unit 2. In the case where the print data has been received (YES in step S81), in step S82, the printer controller 33 accumulates the received print data in the memory 33b and performs a process at the time of print data reception. On the other hand, in the case where the print data has not been received (NO in step S81), the printer controller 33 monitors the operation of turning off the power supply of the image forming apparatus 1 in step S83, and continues to monitor whether print data has been received until the power supply is turned off.

In the process at the time of print data reception illustrated in FIG. 8B, in step S91, the printer controller 33 determines whether the first copy mode is set. In the case where the printer controller 33 determines that the first copy mode is not set (NO in step S91), in step S96, the printer controller 33 determines whether the second copy mode is set. The first copy mode and the second copy mode are set through the copy mode setting process in step S101. For example, in the case where the printer controller 33 determines that neither the first copy mode nor the second copy mode is set (NO in step S91 and NO in step S96), the printer controller 33 determines the type of the received print data in the copy mode setting process of step S101. In the case where the received print data is determined to be the first print data, the printer controller 33 sets the first copy mode. In the case where the received print data is determined to be the second print data, the printer controller 33 sets the second copy mode.

After setting the copy mode, the printer controller 33 shifts to the process of step S91. The manner of setting the copy mode is not limited to the above-described processes. For example, the printer controller 33 may be configured to operate in the first copy mode under normal operating conditions, and set the second copy mode when receiving an instruction to change to the second copy mode from the scanner unit 2 or the controller unit 4.

In the case where the printer controller 33 determines that the first copy mode is set (YES in step S91), the printer controller 33 determines whether print processing can be executed based on the first print data in step S92. For example, in the case where the amount of the first print data accumulated in the memory 33b reaches a predetermined data amount required for printing, the printer controller 33 determines that the print processing can be executed based on the first print data. In the case where the printer controller 33 determines that the print processing cannot be executed based on the first print data (NO in step S92), the printer controller 33 ends the process of the current cycle and starts the process of the next cycle (return). On the other hand, in the case where the printer controller 33 determines that the print processing can be executed based on the first print data (YES in step S92), the printer controller 33 executes the print processing based on the first print data in step S93.

In step S94, the printer controller 33 determines whether the print processing based on all pieces of the first print data required for printing is completed. In the case where the printer controller 33 determines that the print processing is not completed (NO in step S94), the printer controller 33 ends the process of the current cycle and starts the process of the next cycle (return). In the case where the printer controller 33 determines that the print processing is completed (YES in step S94), the printer controller 33 cancels the first copy mode in step S95, and starts the process of the next cycle (return).

In the case where the printer controller 33 determines that the second copy mode is set (YES in step S96), the printer controller 33 determines whether print processing can be executed based on the second print data in step S97. For example, in the case where the amount of the second print data accumulated in the memory 33b reaches a predetermined data amount required for printing, the printer controller 33 determines that the print processing can be executed based on the second print data. In the case where the printer controller 33 determines that the print processing cannot be executed based on the second print data (NO in step S97), the printer controller 33 ends the process of the current cycle and starts the process of the next cycle (return). On the other hand, in the case where the printer controller 33 determines that the print processing can be executed based on the second print data (YES in step S97), the printer controller 33 executes the print processing based on the second print data in step S98.

In step S99, the printer controller 33 determines whether the print processing based on all pieces of the second print data required for printing is completed. In the case where the printer controller 33 determines that the print processing is not completed (NO in step S99), the printer controller 33 ends the process of the current cycle and starts the process of the next cycle (return). In the case where the printer controller 33 determines that the print processing is completed (YES in step S99), the printer controller 33 cancels the second copy mode in step S100, and starts the process of the next cycle (return).

Although the specific example of the control has been described above, another control may be used as long as the processes of FIGS. 3A and 3B can be performed.

### Modification of First Embodiment

In the first embodiment, the scanner controller 23 controls the first bus switch 44 and the second bus switch 45. However, the configuration is not limited thereto. For example, as indicated by the dotted lines in FIG. 1, the printer controller 33 may control the first bus switch 44 and the second bus switch 45. In this case, in response to receiving a copy command, the printer controller 33 (a detection device) communicates with the main controller 41. In the case where communication with the main controller 41 is not established, the printer controller 33 switches the first bus switch 44 and the second bus switch 45 to the state illustrated in FIG. 3B. With such a configuration, the operational effects equivalent to those of the first embodiment can be obtained.

Alternatively, as indicated by the other dotted lines in FIG. 1, the main controller 41 may control the first bus switch 44 and the second bus switch 45. For example, in the case where there is a failure in the local memory 41f or the HDD 41h included in the main controller 41 and the ASIC 41 is operating under normal conditions, the ASIC 41 can control the first bus switch 44 and the second bus switch 45. With such a configuration, the operational effects equivalent to those of the first embodiment can be obtained.

### Second Embodiment

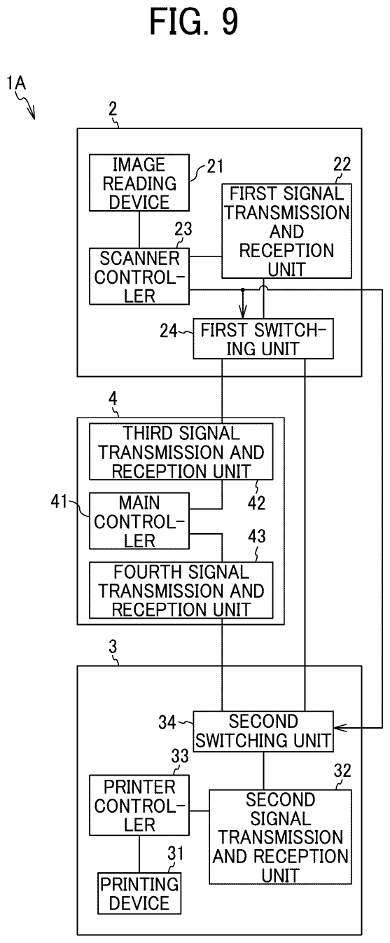

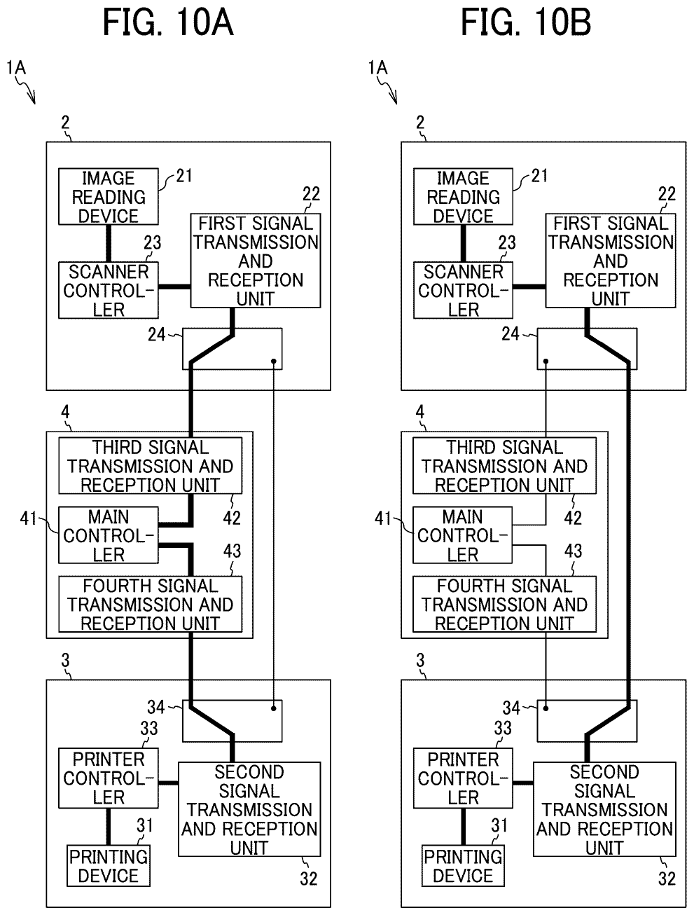

In the image forming apparatus 1 according to the first embodiment, the first bus switch 44 is disposed between the third signal transmission and reception unit 42 and the main controller 41, and the second bus switch 45 is disposed between the main controller 41 and the fourth signal transmission and reception unit 43. However, the configuration is not limited thereto. FIG. 9 is a schematic diagram illustrating an overall configuration of an image forming apparatus 1A according to a second embodiment. FIG. 10A is a diagram schematically illustrating the flow of data in the normal mode according to the second embodiment. FIG. 10B is a diagram schematically illustrating the flow of data when the main controller 41 has a failure, according to the second embodiment. The image forming apparatus 1A according to the second embodiment is characterized in that the scanner unit 2 includes a first switching unit 24 (a path changing device) and the printer unit 3 includes a second switching unit 34 (a path changing device).

The first switching unit 24 has a configuration of switching the path between the first signal transmission and reception unit 22 and the third signal transmission and reception unit 42 included in the controller unit 4 or the second switching unit 34 included in the printer unit 3. The second switching unit 34 has a configuration of switching the path between the second signal transmission and reception unit 32 and the fourth signal transmission and reception unit 43 included in the controller unit 4 or the first switching unit 24 included in the scanner unit 2. The first switching unit 24 and the second switching unit 34 are controlled by, for example, the scanner controller 23, but may also be controlled by the main controller 41 or the printer controller 33.

As illustrated in FIG. 10A, in the case of the first state in which the controller unit 4 can generate the first print data, the first switching unit 24 connects the first signal transmission and reception unit 22 and the third signal transmission and reception unit 42 to be communicable with each other. Similarly, in the case of the first state, the second switching unit 34 connects the fourth signal transmission and reception unit 43 and the second signal transmission and reception unit 32 to be communicable with each other. Accordingly, in the case of the first state, the scan data transmitted from the scanner controller 23 is input to the main controller 41 (ASIC 41c) through the first signal transmission and reception unit 22, the first switching unit 24, and the third signal transmission and reception unit 42. Subsequently, the first print data generated by the main controller 41 is input to the printer controller 33 through the fourth signal transmission and reception unit 43, the second switching unit 34, and the second signal transmission and reception unit 32. The printer controller 33 controls, based on the first print data, the printing device 31 to print an image on a recording medium.

As illustrated in FIG. 10B, in the case of the second state in which the controller unit 4 does not generate the first print data, the first switching unit 24 connects the first signal transmission and reception unit 22 and the second switching unit 34 to be communicable with each other. Similarly, in the case of the second state, the second switching unit 34 connects the first switching unit 24 and the second signal transmission and reception unit 32 to be communicable with each other. Accordingly, in the case of the second state, the second print data generated by the scanner controller 23 is input to the printer controller 33 through the first signal transmission and reception unit 22, the first switching unit 24, the second switching unit 34, and the second signal transmission and reception unit 32. The printer controller 33 controls, based on the second print data, the printing device 31 to print an image on a recording medium.

As described above, according to the image forming apparatus 1A of the second embodiment, the copying function can also be maintained in the second state in which the controller unit 4 does not generate print data.

### Third Embodiment

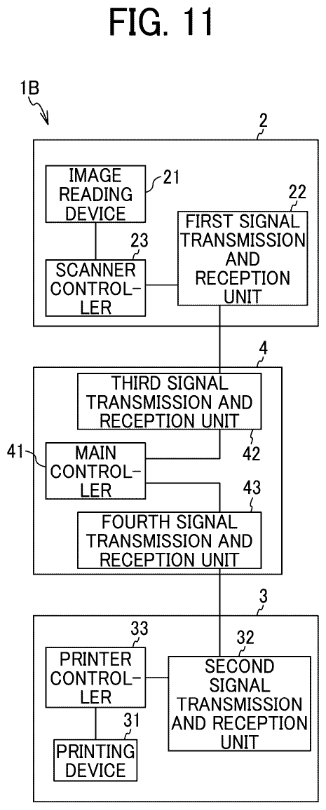

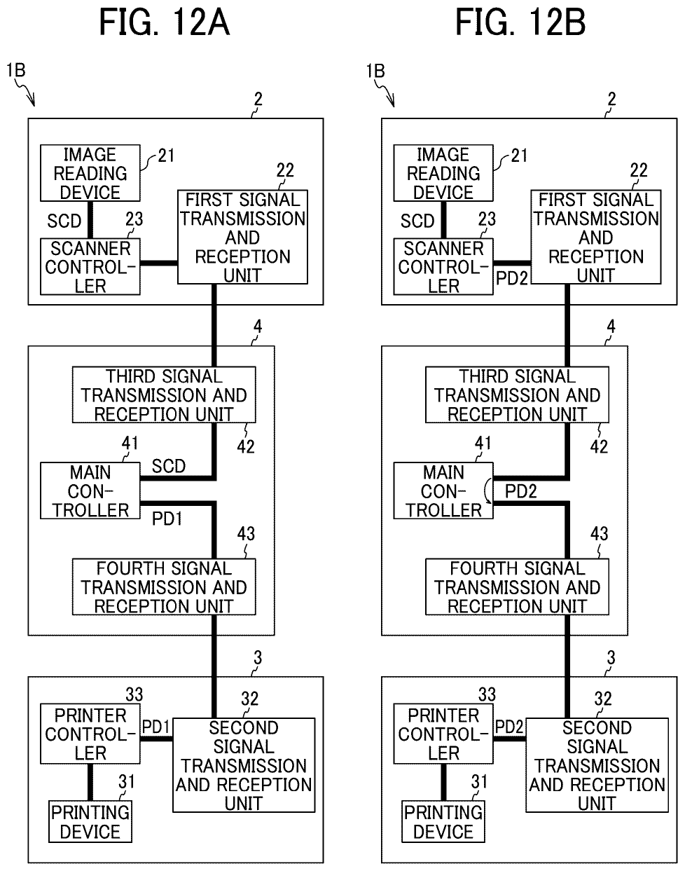

The image forming apparatus 1 according to the first embodiment described above includes the first bus switch 44 and the second bus switch 45. The image forming apparatus 1A according to the second embodiment includes the first switching unit 24 and the second switching unit 34. However, the configurations are not limited thereto. For example, in an energy saving mode (a standby state), copying may be performed without operations performed by the main controller 41. FIG. 11 is a schematic diagram illustrating an overall configuration of an image forming apparatus 1B according to a third embodiment. FIG. 12A is a diagram schematically illustrating the flow of data in the normal mode according to the third embodiment. FIG. 12B is a diagram schematically illustrating the flow of data in the energy saving mode according to the third embodiment. The image forming apparatus 1B according to the third embodiment is characterized in that the main controller 41 connects the third signal transmission and reception unit 42 and the fourth signal transmission and reception unit 43 to each other in the energy saving mode.

As illustrated in FIG. 12A, in the normal mode, the main controller 41 receives scan data (e.g., image data in the RGB format) indicated by a reference sign SCD from the scanner unit 2. The scan data indicated by the reference sign SCD may be referred to simply as the scan data SCD in the following description. Subsequently, the main controller 41 generates the first print data indicated by a reference sign PD1 based on the scan data SCD, and transmits the first print data indicated by the reference sign PD1 to the printer unit 3. The first print data indicated by the reference sign PD1 may be referred to simply as the first print data PD1 in the following description. The printer controller 33 included in the printer unit 3 controls, based on the first print data PD1, the printing device 31 to print an image on a recording medium.

For example, in the case where no operation is performed for a predetermined period of time in the normal mode, the main controller 41 shifts to the energy saving mode (standby state) in which power consumption is lower than that in the normal mode. In the image forming apparatus 1B according to the third embodiment, the main controller 41 connects the third signal transmission and reception unit 42 and the fourth signal transmission and reception unit 43 to be communicable with each other immediately before shifting to the energy saving mode. In the case where an operation is performed on the operation panel 52 in the energy saving mode and the copy mode is selected, the operation unit 5 allows the operator to select one of the normal copy mode and a simple copy mode. In the normal copy mode, the mode is switched to the normal mode and copying is performed. In the simple copy mode, copying is performed while remaining in the energy saving mode.

In the case where the normal copy mode is selected, the main controller 41 shifts to the normal mode, and the copying is performed in the flow described with reference to FIG. 12A. On the other hand, in the case where the simple copy mode is selected, the main controller 41 remains in the energy saving mode. Then, as illustrated in FIG. 12B, the scanner controller 23 generates the second print data indicated by a reference sign PD2 based on the scan data SCD, and transmits the second print data indicated by the reference sign PD2 to the controller unit 4. The second print data indicated by the reference sign PD2 may be referred to simply as the second print data PD2 in the following description. In the controller unit 4, the third signal transmission and reception unit 42 and the fourth signal transmission and reception unit 43 are communicably connected to each other by the main controller 41. Thus, the second print data PD2 is transmitted to the printer unit 3. The printer controller 33 included in the printer unit 3 controls, based on the second print data PD2, the printing device 31 to print an image on a recording medium.

As described above, according to the image forming apparatus 1B of the third embodiment, the copying can be performed while remaining in the energy saving mode (e.g., in the standby state or the second state in which the controller unit 4 does not generate print data).

### Other Modifications

In the above-described embodiments, the printing device 31 is a printer employing an electrophotographic method or an inkjet printing system, but is not limited to these types. The printing device 31 may be a printer employing a thermal recording method or a thermal transfer recording method. The copy sheet is given by way of example as a recording medium, but the recording medium is not limited thereto. The recording medium may be, for example, a postcard, an envelope, coated paper such as art paper, tracing paper, an overhead projector (OHP) transparency, an OHP film, or a prepreg.

Furthermore, the configurations of the scanner controller 23, the printer controller 33, and the main controller 41 are not limited to the configurations exemplified in the above-described embodiments. For example, some of the components of the scanner controller 23, the printer controller 33, and the main controller 41 may be implemented by SoCs or hardware logic, or may be implemented by software.

Aspects of the present disclosure are, for example, as follows.

According to Aspect 1, an image forming apparatus includes the scanner unit 2, the printer unit 3, and the controller unit 4. The scanner unit 2 reads an image of a document to acquire scan data (e.g., image data in the RGB format). The printer unit 3 prints an image on a recording medium such as a copy sheet based on print data (e.g., the first print data or the second print data). The controller unit 4 communicates with the scanner unit 2 and the printer unit 3 through electrical interfaces (USB interfaces such as the first signal transmission and reception unit 22, the second signal transmission and reception unit 32, the third signal transmission and reception unit 42, and the fourth signal transmission and reception unit 43) and generates the first print data based on the scan data transmitted from the scanner unit 2 in the case where the image forming apparatus is in the first state (e.g., in the normal mode). In the case where the image forming apparatus is in the second state (a state where the controller unit 4 has a failure or the standby state) in which the controller unit 4 does not generate the first print data, the scanner unit 2 generates the second print data based on the acquired scan data. The printer unit 3 prints an image on a recording medium based on the first print data in the case where the image forming apparatus is in the first state, and prints an image on a recording medium based on the second print data in the case where the image forming apparatus is in the second state. According to the present aspect, even in a state where the controller unit 4 cannot generate the first print data, the copying functions of the image forming apparatuses 1, 1A, and 1B can be maintained.

According to Aspect 2, the second state is a state in which there is a failure in at least a part of the controller unit 4. According to the present aspect, even in the state in which there is a failure in at least a part of the controller unit 4, the copying functions of the image forming apparatuses 1 and 1A can be maintained.

According to Aspect 3, the second state is the energy saving mode (the standby state) in which power consumption is lower than that in the normal mode (the first state). According to the present aspect, even when the image forming apparatus 1B is in the energy saving mode, copying can be performed while remaining in the energy saving mode.

According to Aspect 4, the image forming apparatus further includes a detection device (e.g., the scanner controller 23 or the printer controller 33) that detects that the first state is changed to the second state. The controller unit 4 includes the main controller 41 that generates the first print data, and forms the first path that allows communication through the main controller 41 in the first state. The controller unit 4 further includes path changing devices such as the first bus switch 44, the second bus switch 45, the first switching unit 24, and the second switching unit 34. When the detection device detects that the image forming apparatus is in the second state, the path changing devices form the second path that allows communication without passing through the main controller 41. According to the present aspect, even in the state in which there is a failure at least a part of the controller unit 4, the copying function of the image forming apparatus 1 can be maintained.

According to Aspect 5, the second print data includes image data in the JPEG format. According to the present aspect, even in a state where the controller unit 4 cannot generate the first print data, the copying functions of the image forming apparatuses 1, 1A, and 1B can be maintained.

According to Aspect 6, the electrical interfaces are USB interfaces. According to the present aspect, even in a state where the controller unit 4 cannot generate the first print data, the copying functions of the image forming apparatuses 1, 1A, and 1B can be maintained.

The above-described embodiments are illustrative and do not limit the present invention. Thus, numerous additional modifications and variations are possible in light of the above teachings. For example, elements and/or features of different illustrative embodiments may be combined with each other and/or substituted for each other within the scope of the present invention. Any one of the above-described operations may be performed in various other ways, for example, in an order different from the one described above.

The functionality of the elements disclosed herein may be implemented using circuitry or processing circuitry which includes general purpose processors, special purpose processors, integrated circuits, application-specific integrated circuits (ASICs), field-programmable gate arrays (FPGAs), and/or combinations thereof which are configured or programmed, using one or more programs stored in one or more memories, to perform the disclosed functionality. Processors are considered processing circuitry or circuitry as they include transistors and other circuitry therein. In the disclosure, the circuitry, units, or means are hardware that carry out or are programmed to perform the recited functionality. The hardware may be any hardware disclosed herein which is programmed or configured to carry out the recited functionality.

There is a memory that stores a computer program which includes computer instructions. These computer instructions provide the logic and routines that enable the hardware (e.g., processing circuitry or circuitry) to perform the method disclosed herein. This computer program can be implemented in known formats as a computer-readable storage medium, a computer program product, a memory device, a record medium such as a CD-ROM or DVD, and/or the memory of an FPGA or ASIC.

1. An image forming apparatus comprising:
an image reading device to read an image of a document to acquire image data;
a printing device to print an image on a recording medium based on print data; and
circuitry configured to communicate with the image reading device and the printing device via electrical interfaces and generate first print data based on the acquired image data in a case where the image forming apparatus is in a first state, wherein,
in a case where the image forming apparatus is in a second state in which the circuitry does not generate the first print data, the image reading device generates second print data based on the acquired image data, and
the printing device prints an image on a recording medium based on the first print data in a case where the image forming apparatus is in the first state, and prints an image on a recording medium based on the second print data in the case where the image forming apparatus is in the second state.

2. The image forming apparatus according to claim 1, wherein the second state is a state in which there is a failure in at least a part of the circuitry.

3. The image forming apparatus according to claim 1, wherein the second state is a standby state in which power consumption is lower than power consumption in the first state.

4. The image forming apparatus according to claim 2, further comprising a detection device to detect that the first state is changed to the second state, wherein:
the circuitry is configured to form a first path, the first path allowing communication through the circuitry in the first state; and
in a case that the detection device detects that the image forming apparatus is in the second state, the circuitry is configured to form a second path, the second path allowing communication without passing through the circuitry.

5. The image forming apparatus according to claim 1, wherein the second print data includes image data in a joint photographic experts group (JPEG) format.

6. The image forming apparatus according to claim 1, wherein the electrical interfaces are universal serial bus (USB) interfaces.
